(19) United States
(12) Patent Application Publication
(10) Pub. No.: US 2012/0010362 A1
(43) Pub. Date: Jan. 12, 2012

(54) METHOD FOR OPTIMIZING ENERGY CONSUMPTION IN AN EXTRUSION PROCESS

(75) Inventor: Mieke Dams, Ekeren (BE)

(73) Assignee: TOTAL PETROCHEMICALS RESEARCH FELUY, Seneffe (Feluy) (BE)

(21) Appl. No.: 13/203,888

(22) PCT Filed: Mar. 31, 2010
(86) PCT No.: PCT/EP2010/054282

§ 371 Date: Aug. 30, 2011

(30) Foreign Application Priority Data
Apr. 2, 2009 (EP) 09157175.2

(51) Int. Cl. C08L 23/06; C08L 23/08

(52) U.S. Cl. 525/51; 525/52

(57) ABSTRACT

The present invention relates to a method for preparing and extruding a bimodal polyethylene product, which comprises a first polyethylene fraction and a second polyethylene fraction having a different molecular weight than the first polyethylene fraction. More specifically, the present invention relates to a method for controlling the specific energy applied on said bimodal polyethylene product by regulating the amount of the polyethylene fraction having the higher molecular weight in said bimodal polyethylene product. According to the present invention regulation of the amount of said polyethylene fraction having the higher molecular weight in said bimodal polyethylene product is obtained by regulating the polymerization conditions for preparing the bimodal polyethylene product, and in particular by adjusting ethylene monomer feed during the polymerization process.

### TECHNICAL FIELD

The present invention relates to the preparation and extrusion process of a bimodal polyethylene product. The present invention provides a method for optimising an extrusion process and in particular for optimizing the energy consumption during an extrusion process. The present invention provides in particular an extrusion process wherein the specific energy applied on a bimodal polyethylene product during extrusion is controlled by regulating the polymerization conditions applied during the preparation of the bimodal polyethylene product.

### BACKGROUND

Polyolefins such as polyethylene may be prepared by particle form polymerization, such as slurry polymerization or gas phase polymerization.

Olefin polymerizations are frequently carried out using monomer, diluent and catalyst and optionally co-monomers and hydrogen in a reactor. When the polymerization is performed under slurry conditions, the product consists usually of solid particles and is in suspension in a diluent. The slurry contents of the reactor are circulated continuously with a pump to maintain efficient suspension of the polymer solid particles in the liquid diluent. The product is discharged by means of settling legs, which operate on a batch principle to recover the product. Settling in the legs is used to increase the solids concentration of the slurry finally recovered as product slurry. The product is further discharged to a flash tank, through flash lines, where most of the diluent and unreacted monomers are flashed off and recycled.

Alternatively, the product slurry may be fed to a second loop reactor serially connected to the first loop reactor where a second polymer fraction may be produced. Typically, when two reactors in series are employed in this manner, the resultant polymer product is a bimodal polymer product, which comprises a first polymer fraction produced in the first reactor and a second polymer fraction produced in the second reactor, and has a bimodal molecular weight distribution.

After the polymer product is collected from the reactor and the hydrocarbon residues are removed therefrom, the polymer product is extruded.

Alternatively, a bimodal polyethylene product may also be produced by physical mixing of the different polyethylene fractions that were prepared separately, e.g. using two reactors, which are operating in parallel.

During the extrusion process ingredients including polymer product, optional additives, etc, are mixed intimately in order to obtain a compound as homogeneous as possible. Usually, this mixing is done in an extruder wherein the ingredients are mixed together and the polymer product and optionally some of the additives are melted so that intimate mixing can occur. The melt is then extruded into a rod, cooled and granulated, e.g. to form pellets. In this form the resulting compound can then be used for the manufacturing of different objects.

Methods for regulating the extrusion process of multimodal polyethylene product have been reported in the art. EP 1 266 738 for instance discloses a method for compounding a multimodal polyethylene composition wherein the extrusion process is regulated in function of the residence time of the polyethylene composition in the extruder.

A problem with extrusion processes is that extrusion of polymer product into pellets is an energy-intensive process. In general up to 40% of the primary energy that is consumed within a polyolefin manufacturing process may be consumed during the extrusion process. Such high energy consumption however contributes to the costs for producing the polyolefins. Also, high energy consumption has an environmental impact.

In view of the above, there remains a need in the art to improve the energy consumption of an extrusion process.

### SUMMARY

The present invention provides an improved method for optimizing an extrusion process, and in particular for optimizing the energy consumption in an extrusion process of a polymer product, in particular of a bimodal polymer product.

The inventors have surprisingly found that energy consumption during the extrusion of a bimodal polymer product can be decreased by regulating the polymerization conditions applied during the preparation of the bimodal polyethylene product, but without changing the specification of the obtained bimodal polymer product. More in particular, the inventors have unexpectedly found that by regulating the amounts of polyethylene fractions in the bimodal polyethylene product, the specific energy (SE) applied on the bimodal polyethylene product during extrusion can be reduced without substantially affecting the properties such as average molecular weight, density, melt index, polydispersity etc., of the obtained bimodal polyethylene product and of the polyethylene fractions contained therein.

In a first aspect, the invention thereto provides a method for optimising the extrusion process of a bimodal polyethylene product, whereby said bimodal polyethylene product comprises at least two different polyethylene fractions that have been obtained by two different polymerisation processes, and whereby one of said fractions has a higher molecular weight than said other fraction, whereby said method comprises regulating the amount of the polyethylene fraction having the higher molecular weight in said bimodal polyethylene product by adjusting the ratio of the amounts of ethylene monomer fed during said two polymerization processes when said amount of said polyethylene fraction having the higher molecular weight deviates from a defined range. The amount of said polyethylene fraction having the higher molecular weight in said bimodal polyethylene product corresponds to the amount in % of this high-molecular weight fraction by weight of said bimodal polyethylene product.

More in particular, the invention provides a method for preparing and extruding a bimodal polyethylene product

wherein said bimodal polyethylene product is prepared in at least two slurry loop reactors connected in series;

whereby said bimodal polyethylene product comprises at least two different polyethylene fractions that have been obtained by two different polymerisation processes, and whereby one of said fractions has a higher molecular weight than said other fraction,

whereby said method comprises regulating the amount of the polyethylene fraction having the higher molecular weight in said bimodal polyethylene product by adjusting the ratio of the amounts of ethylene monomer fed during said two polymerization processes when said amount of said polyethylene fraction having the higher molecular weight deviates from a defined range; and

wherein said bimodal polyethylene product is extruded, optionally in combination with one or more additives.

Said bimodal polyethylene product comprises at least two different polyethylene fractions that have been obtained by at least two different polymerisation processes, whereby each polymerisation process is carried out in a different reactor of the at least two slurry loop reactors connected in series.

In a particular embodiment said method comprises adjusting the ratio (R_{FL/FH}) of the amount of ethylene monomer (FL) fed during the polymerisation process for preparing the polyethylene fraction having the lower molecular weight to the amount of ethylene monomer (FH) fed during the polymerisation process for preparing the polyethylene fraction having the higher molecular weight.

The present invention thus provides a method for optimizing the extrusion process of a bimodal polymer product by monitoring the amount of the polyethylene fraction having the higher molecular weight in the bimodal product and, and by adjusting the ethylene monomer feed ratio (R_{FL/FH}), i.e. the ratio of the amount of ethylene monomer (FL) fed during the polymerisation process for preparing the lower molecular weight polyethylene fraction to the amount of ethylene monomer (FH) fed during the polymerisation process for preparing the higher molecular weight polyethylene fraction when the monitored (measured) amount of higher molecular weight polyethylene fraction falls outside a defined (calculated) range.

The present method permits to control, and in particular to reduce the energy applied on the bimodal polyethylene product during extrusion, by regulating the polymerization conditions applied during the preparation of the bimodal polyethylene product, without substantially changing the properties of the bimodal polyethylene product and the fractions contained therein. The present invention thus provides a method wherein the energy applied on the bimodal polyethylene product during extrusion in an extruder is controlled based on the process conditions for preparing the bimodal polyethylene product. This is unconventional as it is well known in the prior art that extrusion processes are generally regulated by adapting operational conditions of the extruder. Hence one would expect than an extrusion process would be characterised by the characteristics of the extrusion process and not by the characteristics of the process for the preparation of the polymer which is extruded. In view hereof, it is unexpected that in accordance with the present invention the extrusion process is characterised by the characteristics of the polymerisation process for preparing the polymer.

In another embodiment, a method is provided wherein the amount of said polyethylene fraction having the higher molecular weight in said bimodal polyethylene product is regulated by the steps of:
determining a defined range of amount of said polyethylene fraction having the higher molecular weight,
monitoring the actual amount of said polyethylene fraction having the higher molecular weight, and
when said actual amount deviates from said defined range, adjusting said ratio (R_{FL/FH}).

The term “deviates from” as used herein is intended to refer to the situation wherein the actual amount (the amount that is or will be produced) of the fraction having the higher molecular weight falls outside the defined range.

Said ratio is adjusted by adjusting the amount of ethylene monomer fed during the polymerization process for preparing the higher molecular weight fraction and/or during the polymerization process for preparing the lower molecular weight fraction.

The ethylene monomer feed ratio (R_{FL/FH}) is adjusted by adapting/amending the amount of ethylene monomer fed during the polymerisation process for preparing the polyethylene fraction having a lower molecular weight and/or by adapting/amending the amount of ethylene monomer fed during the polymerisation process for preparing the polyethylene fraction having a higher molecular weight.

In a particular embodiment, said ratio (R_{FL/FH}) is discontinuously adjusted.

In a preferred embodiment, said ratio (R_{FL/FH}) is discontinuously adjusted to a constant ratio.

In other words, once adjusted, said ratio (R_{FL/FH}) remains constant until another adjustment is carried out, if needed.

In yet another embodiment, said adjusted ratio (R_{FL/FH}) is comprised within a defined range. In other words, said ratio (R_{FL/FH}) is adjusted to be comprised within a defined range.

In yet another embodiment, the present method comprises the step of adjusting the amount of hydrogen fed during the polymerization process for preparing the polyethylene fraction having the lower molecular weight in function of the amount of the polyethylene fraction having the higher molecular weight in said bimodal polyethylene product.

Preferably the amount of hydrogen fed during the polymerization process for preparing the polyethylene fraction having the lower molecular weight is adjusted (regulated) by the steps of:
determining a defined amount of hydrogen to be fed during the polymerization process for preparing the polyethylene fraction having the lower molecular weight based on the specification of the bimodal polyethylene product, and in particular based on the bimodal molecular weight distribution curve of said bimodal polyethylene product, and even more in particular based on the distance between the two molecular weight peaks of said polyethylene fractions in said curve,
monitoring the actual amount of hydrogen fed during the polymerization process for preparing the polyethylene fraction having the lower molecular weight, and
when said actual amount deviates from said defined amount, adjusting the amount of hydrogen fed during the polymerization process for preparing the polyethylene fraction having the lower molecular weight.

The invention relates in particular to a method for optimising the extrusion process of a bimodal polyethylene product, said bimodal polyethylene product comprising a first polyethylene fraction that has been obtained by a first polymerisation process of ethylene monomer in a diluent in the presence of a catalyst, and a second polyethylene fraction having a different molecular weight, and preferably a lower molecular weight, than the first polyethylene fraction and that has been obtained by a second polymerisation process of ethylene monomer in a diluent in the presence of the catalyst, whereby said method comprises regulating the amount of said first polyethylene fraction in said bimodal polyethylene product by adjusting the ratio of the amounts of ethylene monomer fed during said first and said second polymerization processes when said amount of first polyethylene fraction deviates from a defined range.

In accordance with the present invention, the bimodal polyethylene product can be obtained in different ways. In a preferred embodiment, said bimodal polyethylene product is prepared in at least two slurry loop reactors connected in series. More in particular, said first polyethylene fraction is obtained by carrying out a polymerisation process in a first slurry loop reactor, while said second polyethylene fraction is obtained by carrying out a polymerisation process in a second slurry loop reactor in the presence of said first polyethylene fraction.

More in particular, in one embodiment a method is provided, wherein said bimodal polyethylene product is obtained by the steps of:
feeding ethylene monomer, a diluent, at least one polymerization catalyst, optionally hydrogen, and one or more optional olefin co-monomer(s) to a first reactor,
polymerizing said ethylene in said first reactor to produce a first polyethylene fraction in a slurry in the diluent in said first reactor,
transferring said first polyethylene fraction, diluent and catalyst from said first reactor to a second reactor,
feeding ethylene monomer, a diluent, optionally hydrogen, and one or more optional olefin co-monomer(s) to said second reactor,
polymerizing said ethylene and said one or more optional olefin co-monomer(s) in said second reactor to produce a second polyethylene fraction in said second reactor, said second polyethylene fraction having a different molecular weight than the polyethylene fraction produced in said first reactor, and
recovering from said second reactor a bimodal polyethylene product comprising said first and said second polyethylene fraction;
   and wherein said bimodal polyethylene product is supplied optionally in combination with one or more additives to an extruder. Thus, a bimodal polyethylene product as prepared as described above is submitted optionally in combination with one or more additives to an extrusion process.

Furthermore, in accordance with the present invention, for both above embodiments, a method is provided wherein hydrogen is added to the reactor wherein the polyethylene fraction having the lower molecular weight is prepared.

In a preferred embodiment, a method is provided wherein said second polyethylene fraction produced in said second reactor has a lower molecular weight than said first polyethylene fraction produced in said first reactor. In yet another preferred embodiment, a method is provided comprising feeding hydrogen to said second reactor. In another preferred embodiment, the present method comprises the step of adjusting the amount of hydrogen fed to said second reactor in function of the amount of said first polyethylene fraction. Adjustment is carried out as explained above.

Ethylene monomer feed to the first and the second reactor determines several process control parameters, e.g. co-monomer feed, ratio of co-monomer/monomer feed, hydrogen feed, ratio of hydrogen feed to monomer feed, etc. It is therefore generally accepted that performing a polymerisation process at a constant and fixed ratio of ethylene monomer fed to the second reactor to the amount of ethylene monomer fed to the first reactor is beneficial for the stability of the polymerisation process. It is therefore also preferred to keep during polymerization processes the ratio of amount of ethylene monomer fed to the second reactor to the amount of ethylene monomer fed to the first reactor at a substantially fixed and constant value.

However, in spite of this teaching, the inventors have in accordance with the present method adapted the polymerization conditions in function of the product output, i.e. the amounts in weight % of produced polymer fractions, and have modified during the polymerization processes the input conditions, i.e. the ethylene feed during the first and second polymerization processes. In particular, the ratio of the amount of ethylene monomer fed to the second reactor to the amount of ethylene monomer fed to the first reactor is adjusted according to the present method.

The present invention allows reducing energy consumption in the extrusion process of bimodal polyethylene. The present invention improves plant efficiency.

The present method also permits to prepare a bimodal polyethylene product having improved consistency and made of a certain desired amount of high and low molecular weight fraction. For instance, in an embodiment, a method is provided wherein the weight percentage of said polyethylene fraction having the higher molecular weight in said bimodal polyethylene product is comprised between 70 and 30 wt %, and preferably between 60 and 40 wt %. In another embodiment a method is provided wherein the weight percentage of said polyethylene fraction having the lower molecular weight in said bimodal polyethylene product is comprised between 30 and 70 wt %, and preferably between 40 and 60 wt %. In other words, a method is provided wherein the ratio of the weight percentage of said polyethylene fraction having the higher molecular weight to the weight percentage of said polyethylene fraction having the lower molecular weight in said bimodal polyethylene product is comprised between 70:30 and 30:70, and preferably between 60:40 and 40:60.

Polymerisation processes according to the invention are carried out in the presence of a polymerisation catalyst. In an embodiment a method is provided wherein said polymerization processes are carried out in the presence of a Ziegler-Natta catalyst. In another embodiment, a method is provided wherein said polymerization processes are carried out in the presence of a chromium catalyst.

The present invention will be further disclosed in detail hereunder. The description is only given by way of example and does not limit the invention.

### BRIEF DESCRIPTION OF THE FIGURES

FIG. 1 schematically represents the specific energy applied to bimodal polyethylene products in prior art extrusion processes (period A), and applied to bimodal polyethylene products (B) in extrusion processes that have been optimized according to a method of the present invention (period B).

FIG. 2 schematically represents the weight % amount of high molecular weight (HMW) polymer fraction comprised within bimodal polyethylene products obtained with prior art polymerization processes (period A), and comprised within bimodal polyethylene products obtained with polymerization processes that are regulated in accordance with a method of the present invention (period B).

FIG. 3 schematically represents the ratio of hydrogen off gas to ethylene monomer off gas present during the preparation of bimodal polyethylene products in accordance with prior art polymerization processes (period A) and polymerization processes that are regulated in accordance with a method of the present invention (period B).

### DETAILED DESCRIPTION OF THE INVENTION

The present invention is directed to a method for regulating the extrusion process of a bimodal polyethylene product comprising at least two different polyethylene fractions that have been obtained by two different polymerisation processes, and whereby one fraction has a higher molecular weight than said other fraction. For instance, the invention provides a method for regulating the extrusion process of a bimodal polyethylene product comprising a first polyethylene fraction and a second polyethylene fraction having a different, and preferably a lower, molecular weight than the first polyethylene fraction. The method comprises the step of regulating the amount in weight % of the bimodal product of the polyethylene fraction having the higher molecular weight in said bimodal polyethylene product by amending the ratio of the amounts of ethylene monomer fed during said two polymerization processes, in the event that said amount of said polyethylene fraction having the higher molecular weight deviates from a defined range. The present method thus permits to control the energy applied on said bimodal polyethylene product during the extrusion process by regulating the amount of the higher molecular weight polyethylene fraction in said bimodal polyethylene product.

The term “bimodal polyethylene product” or “bimodal polyethylene composition” as used in the present invention is meant to designate products or compositions comprising “bimodal polyethylene”.

“Bimodal polyethylene” refers to polyethylene comprising at least two fractions of ethylene polymer wherein one fraction has a lower molecular weight than the other fraction. Bimodal PE can be produced in a sequential step process, utilizing polymerization reactors coupled in series and using different conditions in each reactor, the different fractions produced in the different reactors will each have their own molecular weight.

Besides bimodal PE, a bimodal polyethylene product as defined herein may further comprise additives, such as but not limited to antioxidants, anti-UV agents, anti-static agents, dispersive aid agents, processing aids, colorants, pigments, etc. The total content of these additives does generally not exceed 10 parts, preferably not 5 parts, by weight per 100 parts by weight of a bimodal polyethylene product.

In an embodiment a polymerization process for preparing bimodal polyethylene is carried out in a double loop polymerization reactor unit consisting of two liquid full loop reactors, comprising a first and a second reactor connected in series by one or more settling legs of the first reactor connected for discharge of slurry from the first reactor to said second reactor. The first polyethylene fraction, diluent and catalyst can be continuously or discontinuously transferred from said first reactor to said second reactor.

Prior art methods have been described reporting the preparation of bimodal polyethylene in a reactor unit comprising two serially connected reactors. For instance WO 2008/066604 discloses the preparation of bimodal polyethylene in two slurry reactors. In this document, the slurry that is prepared in the first slurry reactor is transferred into a flash drum where a portion of the volatile materials are removed before being transferred to the second slurry reactor. This document does not disclose the step of regulating the ratio of ethylene feed during the polymerization processes in the respective slurry reactors.

In contrast, in accordance with the present method, slurry which is transferred from the first to the second reactor is not devolatized prior to entry in the second reactor. Hence, this slurry issued form the first loop reactor may still contain volatiles and unreacted components, such as for instance ethylene monomer. However, despite the presence of components such as e.g. ethylene monomer that may remain in the slurry containing the first polyethylene fraction that is transferred from the first to the second reactor, a bimodal polyethylene product is prepared in accordance with the present method which can be extruded in a more efficient way, by applying less energy and at lower energetic cost.

Ethylene polymerization includes but is not limited to homopolymerization of ethylene, copolymerization of ethylene and a higher 1-olefin co-monomer such as 1-butene, 1-pentene, 1-hexene, 1-octene or 1-decene. In an embodiment of the present invention, said co-monomer is 1-hexene.

Ethylene polymerizes in a liquid diluent in the presence of a catalyst, optionally a co-catalyst, optionally a co-monomer, optionally hydrogen and optionally other additives, thereby producing polymerization slurry.

As used herein, the term “polymerization slurry” or “polymer slurry” or “slurry” means substantially a multi-phase composition including at least polymer solids and a liquid phase, the liquid phase being the continuous phase. The solids include catalyst and a polymerized olefin, such as polyethylene. The liquids include an inert diluent, such as isobutane, dissolved monomer such as ethylene, co-monomer, molecular weight control agents, such as hydrogen, antistatic agents, antifouling agents, scavengers, and other process additives.

Suitable diluents are well known in the art and include but are not limited to hydrocarbon diluents such as aliphatic, cycloaliphatic and aromatic hydrocarbon solvents, or halogenated versions of such solvents. The preferred solvents are C₁₂ or lower, straight chain or branched chain, saturated hydrocarbons, C₅ to C₉ saturated alicyclic or aromatic hydrocarbons or C₂ to C₆ halogenated hydrocarbons. Non-limiting illustrative examples of solvents are butane, isobutane, pentane, hexane, heptane, cyclopentane, cyclohexane, cycloheptane, methyl cyclopentane, methyl cyclohexane, isooctane, benzene, toluene, xylene, chloroform, chlorobenzenes, tetrachloroethylene, dichloroethane and trichloroethane. In a preferred embodiment of the present invention, said diluent is isobutane. However, it should be clear from the present invention that other diluents may as well be applied according to the present invention.

Suitable catalysts are well known in the art. According to the present invention the term “catalyst” is defined herein as a substance that causes a change in the rate of a co-polymerization reaction without itself being consumed in the reaction. Examples of suitable catalysts include but are not limited to chromium oxide such as those supported on silica or aluminium, organometal catalysts including those known in the art as “Ziegler” or “Ziegler-Natta” catalysts, metallocene catalysts and the like. The term “co-catalyst” as used herein refers to materials that can be used in conjunction with a catalyst in order to improve the activity of the catalyst during the polymerization reaction. In a preferred embodiment of the present invention, said catalyst is a Ziegler-Natta catalyst. Hence, in a preferred embodiment, a method is provided wherein said polymerization catalyst is a Ziegler-Natta catalyst or a chromium catalyst, and preferably a Ziegler-Natta catalyst. In an example, when using a Ziegler-Natta catalyst or a chromium catalyst, a method is provided wherein the polyethylene fraction having a higher molecular weight is prepared in the first reactor and the polyethylene fraction having a lower molecular weight is prepared in the second reactor.

More in particular, in an embodiment, a first polyethylene fraction is obtained by a first polymerisation process of ethylene monomer in a diluent in the presence of a catalyst. Such first polymerisation process comprises the steps of feeding ethylene monomer, a diluent, at least one polymerization catalyst, optionally hydrogen, and one or more optional olefin co-monomer(s) to said first reactor, and polymerizing said ethylene in said first reactor to produce a first polyethylene fraction in a slurry in the diluent in said first reactor. Hereafter, the first polyethylene fraction, diluent and catalyst is transferred from said first reactor to a second reactor. In the second reactor a second polyethylene fraction is obtained by feeding ethylene monomer, a diluent, optionally hydrogen, and one or more optional olefin co-monomer(s) to said second reactor; polymerizing said ethylene and said one or more optional olefin co-monomer(s) in said second reactor to produce a second polyethylene fraction in said second reactor. Said second polyethylene fraction has a different molecular weight than the polyethylene fraction produced in said first reactor. From the second reactor bimodal polyethylene product comprising said first and said second polyethylene fraction is then recovered. This bimodal polyethylene product is then supplied, optionally in combination with one or more additives to an extruder.

In a preferred embodiment of the above method, ethylene monomer is fed during the first and the second polymerisation reactions to respectively the first and second reactors at a fixed ethylene monomer feed ratio. The term “ethylene monomer feed ratio” as used herein refers to the ratio of the amount of ethylene monomer fed to the reactor wherein the lower molecular weight PE fraction is prepared (FL), in accordance with the above preferred embodiment this is the second reactor, over the amount of ethylene monomer fed to reactor wherein the higher molecular weight PE fraction is prepared, in accordance with the above preferred embodiment this is the first reactor.

In a particularly preferred embodiment of the above method, said second polyethylene fraction produced in said second reactor has a lower molecular weight than said first polyethylene fraction produced in said first reactor. In another preferred embodiment, hydrogen is added to the second reactor wherein the second polyethylene fraction is produced having a lower molecular weight than said first polyethylene fraction.

In a preferred embodiment, said first polyethylene fraction prepared in said first reaction is a high-molecular-weight (HMW) component, composed of an ethylene homopolymer or copolymer, for instance with a weight-average molar mass 300,000 g/mol, preferably from 300,000 to 700,000 g/mol and very particularly preferably from 300,000 to 600,000 g/mol, and preferably having a higher molecular weight than the second polyethylene fraction. In another preferred embodiment, said second polyethylene fraction prepared in said second reaction is a low-molecular-weight (LMW) component, composed of an ethylene homopolymer or ethylene copolymer, for instance with a weight-average molar mass of from 8000 to 80,000 g/mol, preferably from 20,000 to 70,000 g/mol and very particularly preferably from 30,000 to 60,000 g/mol, and preferably having a lower molecular weight than the first polyethylene fraction.

The present invention provides a method for optimizing the extrusion process of a bimodal polyethylene product. By “optimising the extrusion process” is meant “regulating” the extrusion process, and in particular “reducing” the energy consumed or applied during the extrusion process.

In the method according to the invention, the “energy”, more commonly known as “specific energy” (SE) applied on the bimodal polyethylene product during extrusion is the ratio of consumed power in an extruder, expressed in kW, and the rate of polymer product throughput in the extruder, expressed in kg/h.

The inventors have now found that there is a correlation between the amount of high molecular weight polymer fraction present in a bimodal polyethylene product and the specific energy required during the extrusion process for extruding said bimodal PE product. The invention therefore provides a method for extruding a bimodal polyethylene product as defined herein, wherein the specific energy applied on said bimodal polyethylene product is controlled by regulating the amount of said high molecular weight polyethylene fraction present in said bimodal polyethylene product. In particular, the amount of said high molecular weight polyethylene fraction present in said bimodal polyethylene is regulated to be comprised within a defined range.

The method according to the present invention comprises the step of regulating the amount of said first polyethylene fraction in said bimodal polyethylene product by adjusting the ratio (R_{FL/FH}) of the amount of ethylene monomer fed during the second polymerization reaction to the second reactor (FL) to the amount of ethylene monomer fed during the first polymerization reaction to the first reactor (FH).

The term “regulating” the amount of said first polyethylene fraction in said bimodal PE product as used herein includes adapting or controlling the amounts of high and low molecular weight PE fraction in the bimodal product.

The term “amount” in this context refers to the amount in weight percentage (in wt %) of a PE fraction in the bimodal product.

In a preferred embodiment, a method is provided wherein the ratio of the weight percentage of said polyethylene fraction having the higher molecular weight to the weight percentage of said polyethylene fraction having the lower molecular weight in said bimodal polyethylene product is comprised between 70:30 and 30:70, and preferably between 60:40 and 40:60, or between 55:45 and 45:55. In an example, said ratio of weight percentages is about 50:50.

It is generally accepted in the prior art that the more high molecular weight PE fraction is present in a bimodal product the easier extrusion of the bimodal product will be, because in such a case the melt index (or viscosity) of the high molecular weight PE fraction is closer to the melt index (or visocity) of the final bimodal product. However, despite this teaching, the inventors have reduced the proportional amount of high molecular weight polyethylene fraction in the bimodal product compared to amounts that are usually applied in the art, and have unexpectedly found that by doing so, they were able to significantly optimize the extrusion process, in particular by reducing the consumption of energy (SE) during such process, without however substantially changing the specification of the bimodal product.

In a particular embodiment, a method is provided wherein the amount of said first polyethylene fraction present in said bimodal polyethylene product by discontinuously varying the ratio (R_{FL/FH}) of the amount of ethylene monomer (FL) fed during said second polymerisation process to the amount of the ethylene monomer (FH) fed during said first polymerisation process within a defined range.

In particular, a method is provided wherein the amount of said first polyethylene fraction present in said bimodal polyethylene product is regulated by the steps of:
determining a defined range of amount of said first polyethylene fraction in said bimodal polyethylene product,
determining the actual amount of said first polyethylene fraction, and
in the event that said actual amount falls outside said defined range, adjusting the ratio (R_{FL/FL}) by adjusting the amount of ethylene monomer fed to said first and/or to said second reactor.

The term “defined range” of amounts of said first polyethylene fraction as used herein is intended to refer to a “range” that has been theoretically determined (calculated) and that is required for A) preparing a final bimodal PE complying with prescribed product properties such as e.g. density, melt index, mechanical properties etc. and B) controlling the specific energy applied during extrusion within an acceptable amount.

The term “actual” amount of said first polyethylene fraction as used herein refers to the amount of said first polyethylene fraction that will be present in the final bimodal PE based on the actual process parameters such as e.g. the amount of ethylene fed to the first and second reactor, optional co-monomer feed to the first reactor, ratio of co-monomer/monomer feed, hydrogen feed to the second reactor, ratio of hydrogen feed to monomer feed, etc. In a preferred embodiment said “actual” amount is determined, measured or monitored based on the running process conditions.

When the actual amount of said first polyethylene fraction is determined to deviate from (i.e. to fall outside) said defined range the ratio (R_{FL/FH}) of amount of ethylene monomer fed to the second reactor to the amount of ethylene monomer fed to the first reactor is adjusted. Adjustment can be done manually. Adjustment is carried out by adjusting the feed of ethylene monomer to said first and/or to said second reactor.

In another embodiment, a method is provided wherein the ratio (R_{FL/FH}) is adjusted discontinuously, i.e. from time to time. In yet another embodiment, the (R_{FL/FH}) is adjusted discontinuously to a constant ratio. In other words, between two adjustment cycles, the (R_{FL/FH}) ratio is kept at a constant value. This value however is comprised within a defined range for the ratio (R_{FL/FH}). This means that once adjusted, the ratio (R_{FL/FH}) remains fixed and constant, until another adjustment is carried out, if any. Once a suitable (R_{FL/FH}) ratio for the ethylene feed to the first and the second reactor has been determined in accordance with the present method, this ratio (R_{FL/FH}) remains constant, until another adjustment is carried out, if any. This advantageously permits to avoid variations in the feed of co-monomer and/or hydrogen to the reactor(s) which could destabilize the polymerization process.

In another preferred embodiment, a method is provided wherein the adjusted ratio (R_{FL/FH}) is comprised within a defined range. Adjusting the (R_{FL/FH}) ratio within a defined range has the advantage that the regulation mechanism according to the invention has no or at least no substantial effect on the product properties of the obtained polyethylene fractions and of the obtained bimodal PE. Thus, a method is provided wherein the step of adjusting said (R_{FL/FH}) ratio does not substantially change the properties, such as e.g. density, MI, molecular weight, of the first and second polyethylene fractions and of the bimodal polyethylene. Neither the mechanical properties of the bimodal polyethylene are substantially changed.

In another embodiment, the present method comprises the step of regulating the amount of hydrogen fed to said second reactor in function of the amount of said first polyethylene fraction. In this context the term “regulating the amount of hydrogen” also refers to “adapting” or “amending” the amount of hydrogen.

Preferably the amount of hydrogen fed during the polymerization process to said second reactor is regulated by the steps of:
determining a defined amount of hydrogen to be fed to said second reactor in accordance with the specification of the bimodal polyethylene product,
monitoring the actual amount of hydrogen fed to said second reactor, and
when said actual amount deviates from said defined amount, adjusting the amount of hydrogen fed to said second reactor.

More in particular, the amount of hydrogen to be fed to said second reactor is determined or calculated based on the bimodal molecular weight distribution curve of said bimodal polyethylene product, and even more in particular based on the distance between the two molecular weight peaks of said polyethylene fractions in said curve.

The molecular weight distribution curve, i.e. the graph of the polymer weight fractions as function of its molecular weigh, is for a bimodal product generally characterized by the appearance of the two distinct peaks. In accordance with the present method, initially, the amount of hydrogen fed to said second reactor is set (determined) according to the specifications (i.e. the characteristics) of the bimodal polyethylene product. More in particular, the amount of hydrogen to be fed is set in accordance with the bimodal molecular weight distribution curve of said bimodal polyethylene product, and more in particular in accordance with the relative distance between the two molecular weight peaks of said polyethylene fraction on this curve, i.e. the separation of the molecular weight blocks. The actual amount of hydrogen fed to the second reactor is measured and in the event that this actual amount differs from the determined amount, the hydrogen feed to said second reactor is amended.

When regulating the amount of high molecular weight PE fraction present in the bimodal PE, the need for hydrogen in the second polymerization reactor will also change. In some advantageous cases, when controlling the specific energy applied during the extrusion process, by lowering the amount of high molecular weight PE fraction present in the bimodal PE, less hydrogen will be necessary in the second reactor. In contrast, when using high amounts of hydrogen in the second reactor, the process gases will less easily dissolve in the liquid slurry, gas bells may then be formed in the reactor, which may lead to pressure differences and problems to discharge the polymer product. This type of problems can thus be reduced in accordance with the present method, by controlling, i.e. lowering, the amount of hydrogen fed to the second reactor.

Another beneficial effect of a lower hydrogen feed to the second reactor is that the productivity of the catalyst can be improved, such that less catalyst will be necessary in the polymerization process.

Before being supplied to an extruder, bimodal PE product issued from the second reactor is discharged to a flash tank, through flash lines, where most of the diluent and unreacted monomers are flashed off. It is desirable to further treat the vapors in order to recover the unreacted monomer, unreacted co-monomer and the diluent, since there is an economic interest in re-using these separated components including the monomer, co-monomer, and the diluent, in a polymerization process. According to the present invention another advantageous effect of controlling, in particular of lowering, the hydrogen feed to the second reactor is that it will be easier to recover ethylene monomer and that less byproducts (heavies) will need to be removed in the recycle section.

When extruding a bimodal PE product, e.g. for the production of film, gel particles may occur. These gel particles appear as disfiguring heterogeneities in the finished film and consist mainly of high molecular weight polymer particles that have not been adequately compounded, i.e. dispersed, in the composition. It is generally known in the art that there is a negative correlation between the amount of energy applied during extrusion and the formation of gels in the obtained polymer product; i.e. the higher the amount of specific energy, the lower the gel content in the obtained polymer product. In view thereof, it is unexpected that the present extrusion method permits to provide a homogenous polymer product of suitable product consistency and quality without substantially any degradation of the polymers present in the product and without increasing the amounts of gel formed, even if a lower amount of energy is applied during the extrusion process. Moreover, this advantageous effect is obtained irrespective of the residence time of the polymer product in the extruder.

In yet another embodiment, a method is provided wherein specific energy input during extrusion is lowered, compared to a method wherein there is no regulation of the amount of the high molecular weight polyethylene fraction, by at least 0.010 kWh/kg bimodal polyethylene product, and preferably even with at least 0.020 kWh/kg bimodal polyethylene product. Such reduction in energy input results in a considerable reduction of the primary energy applied in the polyolefin manufacturing plant, and contributes to considerable cost-saving for producing the bimodal PE product.

Another beneficial effect of the present method is that bimodal polyethylene products are obtained which have improved consistency.

In an example, the invention provides a method for optimising the extrusion process as defined herein of a bimodal polyethylene product, wherein said bimodal polyethylene product comprises a first polyethylene fraction, and a second polyethylene fraction having a lower molecular weight, than the first polyethylene fraction. The method comprises regulating the amount of said first polyethylene fraction in said bimodal polyethylene product by adjusting the ratio of the amounts of ethylene monomer fed during said first and said second polymerization processes when said amount of first polyethylene fraction deviates from a defined range.

Preferably said bimodal polyethylene product is a product that is suitable for the production of pipe products. In an example said bimodal polyethylene product has amongst other features the following properties, e.g. a density comprising about 0.9585 g/cc and a melt index comprising about 0.27 g/10 minutes.

In a preferred embodiment, e.g. for this example, said amount of said first polyethylene fraction in said bimodal polyethylene product is comprised within a defined range of 49 to 52%, and preferably within a defined range of 49.5 to 50.7%.

In another preferred embodiment, e.g. for this example, the ratio (R_{FH/FL}) adjusted in accordance with the present method is comprised within a defined range of 1.03 to 1.08, and preferably within a defined range of 1.05 and 1.08.

In yet another embodiment, e.g. for this example, the invention provides a method wherein said extrusion process is optimized by lowering the specific energy applied on said bimodal polyethylene product during extrusion to less than 0.230 kWh/kg bimodal polyethylene product, and preferably less than 0.210 kWh/kg bimodal polyethylene product, or for instance less than 0.200 kWh/kg bimodal polyethylene product.

The present example illustrates a method according to the invention.

### Example

The present example illustrates polymerization processes wherein bimodal PE has been prepared in a sequential step process, utilizing two polymerization reactors coupled in series, and the extrusion thereof.

In a first series of prior art polymerization processes (period A), the amount of the first (HMW) polyethylene fraction in the bimodal polyethylene product has not been regulated during the polymerization processes. During this first series of polymerization processes (period A), a constant reactor ratio in ethylene feed was applied of about 1.05.

In a second series of polymerization process (period B), the amount of the first (HMW) polyethylene fraction in the bimodal polyethylene product has been regulated during the polymerization process according to a method as described herein. During this second series a reactor ratio in ethylene feed was applied which varied between 1.05 and 1.08.

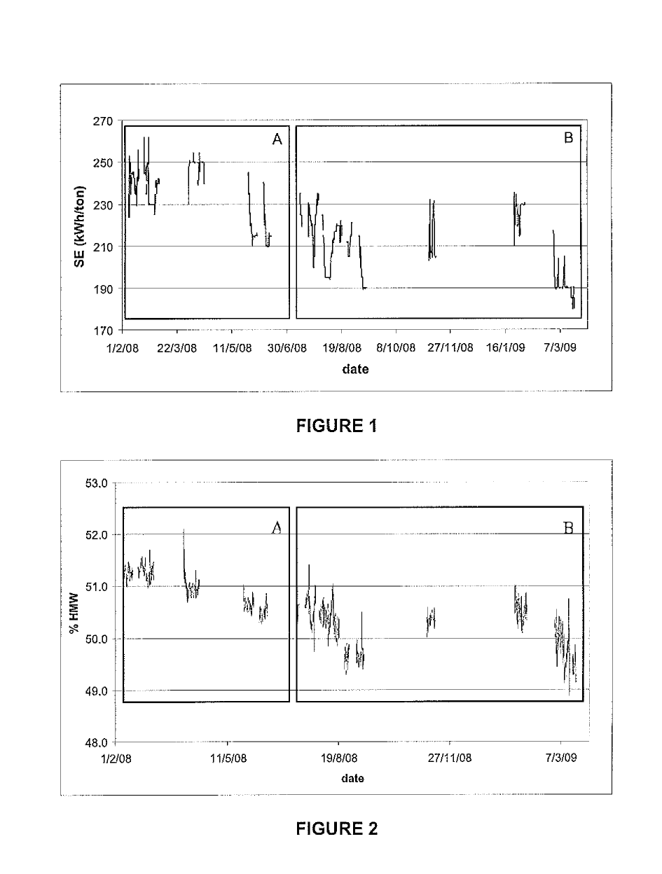

FIG. 1 schematically illustrates the specific energy (SE expressed in kWh/ton bimodal PE) applied during extrusion of bimodal polyethylene products obtained when carrying out the above-mentioned series of polymerization processes.

FIG. 2 schematically illustrates the weight % amount of HMW PE component in the bimodal polyethylene products obtained when carrying out the above-mentioned series of polymerization processes.

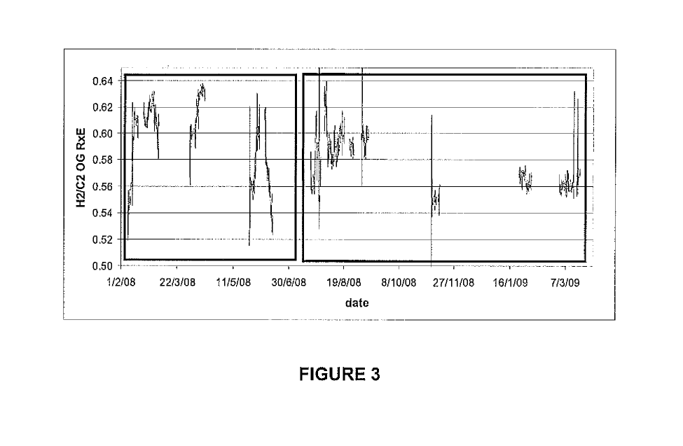

FIG. 3 schematically illustrates the ratio hydrogen off gas/ethylene monomer off gas of the second reactor during the preparation of bimodal polyethylene products in accordance with the above-mentioned series of polymerization processes.

During the first series of prior art polymerisation processes (period A), the amount of HMW in the bimodal PE product was not regulated and varied on average between about 50.5 and 51.5% (see FIG. 2—period A). Further, under these reaction conditions gel formation frequently occurred.

Compared thereto, during the second series of polymerisation processes (period B), the amount of HMW in the bimodal PE product was regulated and varied on average between 49.5 and 50.7% (see FIG. 2—period B). At the start up of the polymerisation processes carried out in period B, a reactor ratio in ethylene feed of 1.05 was applied. During polymerisations however, the reactor ratio in ethylene feed was adjusted in accordance with the above described method. As a result thereof, the specific energy applied during the extrusion processes of bimodal PE product obtained with the second series of polymerisation processes was on average 0.025 kWh/kg bimodal PE product lower (on average about 0.209 kWh/kg bimodal PE is obtained during period B—see FIG. 1) compared to the specific energy applied during the extrusion processes of bimodal PE product obtained with the first series of polymerisation processes (on average 0.236 kWh/kg bimodal PE is obtained during period A—see FIG. 1).

In addition, as illustrated on FIG. 3 (period B) compared to FIG. 3 (period A), regulating the amount of the first (HMW) polyethylene fraction in the bimodal polyethylene product during the polymerization process permits to lower hydrogen off gas.

The adjustment carried out in accordance with the present invention however, did not induce a significant difference in product properties: the bimodal products obtained in the two series of processes were substantially the same.

1. Method for preparing and extruding a bimodal polyethylene product;
wherein said bimodal polyethylene product is prepared in at least two slurry loop reactors connected in series;
whereby said bimodal polyethylene product comprises at least two different polyethylene fractions that have been obtained by two different polymerisation processes, and whereby one of said fractions has a higher molecular weight than said other fraction;
whereby each polymerisation process is carried out in a different reactor of the at least two slurry loop reactors connected in a series;
whereby said method comprises regulating the amount of the polyethylene fraction having the higher molecular weight in said bimodal polyethylene product by adjusting the ratio of the amounts of ethylene monomer fed during said two polymerization processes when said amount of said polyethylene fraction having the higher molecular weight deviates from a defined range; and
wherein said bimodal polyethylene product is extruded, optionally in combination with one or more additives.

2. Method according to claim 1, whereby said method comprises adjusting the ratio (R_{FL/FH}) of the amount of ethylene monomer (FL) fed during the polymerisation process for preparing the polyethylene fraction having the lower molecular weight to the amount of ethylene monomer (FH) fed during the polymerisation process for preparing the polyethylene fraction having the higher molecular weight.

3. Method according to claim 1, wherein the amount of said polyethylene fraction having the higher molecular weight in said bimodal polyethylene product is regulated by the steps of:
determining a defined range of amount of said polyethylene fraction having the higher molecular weight,
monitoring the actual amount of said polyethylene fraction having the higher molecular weight, and
when said actual amount deviates from said defined range, adjusting said ratio (R_{FL/FH}).

4. Method according to claim 1, wherein adjusting said ratio (R_{FL/FH}) is performed by amending the amount of ethylene monomer fed during the polymerisation process for preparing the polyethylene fraction having a lower molecular weight and/or by amending the amount of ethylene monomer fed during the polymerisation process for preparing the polyethylene fraction having a higher molecular weight.

5. Method according to claim 1, wherein said ratio (R_{FL/FH}) is discontinuously adjusted.

6. Method according to claim 5, wherein once adjusted, said ratio (R_{FL/FH}) remains constant until another adjustment is carried out, if needed.

7. Method according to claim 1, wherein said adjusted ratio (R_{FL/FH}) is comprised within a defined range.

8. Method according to claim 1, comprising the step of adjusting the amount of hydrogen fed during the polymerization process for preparing the polyethylene fraction having the lower molecular weight in function of the amount of the polyethylene fraction having the higher molecular weight in said bimodal polyethylene product.

9. Method according to claim 1, wherein said bimodal polyethylene product is obtained by the steps of:
feeding ethylene monomer, a diluent, at least one polymerization catalyst, optionally hydrogen, and one or more optional olefin co-monomer(s) to a first reactor,
polymerizing said ethylene in said first reactor to produce a first polyethylene fraction in a slurry in the diluent in said first reactor,
transferring said first polyethylene fraction, diluent and catalyst from said first reactor to a second reactor,
feeding ethylene monomer, a diluent, optionally hydrogen, and one or more optional olefin co-monomer(s) to said second reactor,
polymerizing said ethylene and said one or more optional olefin co-monomer(s) in said second reactor to produce a second polyethylene fraction in said second reactor, said second polyethylene fraction having a different molecular weight than the polyethylene fraction produced in said first reactor, and
recovering from said second reactor a bimodal polyethylene product comprising said first and said second polyethylene fraction;
and wherein said bimodal polyethylene product is supplied optionally in combination with one or more additives to an extruder.

10. Method according to claim 9, wherein said second polyethylene fraction produced in said second reactor has a lower molecular weight than said first polyethylene fraction produced in said first reactor.

11. Method according to claim 10, comprising feeding hydrogen to said second reactor.

12. Method according to claim 1, wherein the ratio of the weight percentage of said polyethylene fraction having the higher molecular weight to the weight percentage of said polyethylene fraction having the lower molecular weight in said bimodal polyethylene product is comprised between 70:30 and 30:70, and preferably between 60:40 and 40:60.

13. Method according to claim 1, wherein said polymerization processes are carried out in the presence of a Ziegler-Natta catalyst.

14. Method according to claim 1, wherein said polymerization processes are carried out in the presence of a chromium catalyst.
